(19) United States
(12) Patent Application Publication
(10) Pub. No.: US 2010/0210226 A1
(43) Pub. Date: Aug. 19, 2010

(54) COMMUNICATION TERMINAL AND DATA RECEPTION METHOD

(75) Inventor: Mariko Matsuyama, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/602,040

(22) PCT Filed: May 30, 2008
(86) PCT No.: PCT/JP2008/060035

§ 371 Date: Mar. 8, 2010

(30) Foreign Application Priority Data
May 30, 2007 (JP) 2007-143850

(51) Int. Cl. H04B 7/02

(52) U.S. Cl. 455/101

(57) ABSTRACT

It is possible to provide a communication terminal and a data reception method which can continue data reception while performing mutual communication such as an audio communication. A mobile telephone (1) includes a main antenna (410) which transmits and receives a signal; a sub-antenna (510) which receives a signal; and a CPU (60) which performs communication and performs switching between the main antenna (410) and the sub-antenna (510) meanwhile. While predetermined data is being received via the main antenna (410), the CPU (60) waits for a signal arrival via the sub-antenna (510). If a signal arrives while receiving the predetermined data, the reception of the predetermined data is switched to the sub-antenna (510) and the main antenna (410) is used for performing a response process for the received signal.

### TECHNICAL FIELD

The present invention relates to a communication terminal for performing radio communication with a plurality of communication systems, and to a data reception method in the communication terminal.

### BACKGROUND ART

Conventionally, in radio communication terminals such as a cellular telephone device, communication is performed by selecting one of a plurality of communication systems (for example, communication systems with different frequency bands or different base stations) and establishing synchronization therewith. Moreover, in radio communication terminals in recent years, many types with a sub antenna in addition to a main antenna are appearing. More and more of these radio communication terminals are employing a method for receiving another channel via the sub antenna instead of the main antenna, by using an SHDR (Simultaneous Hybrid Dual Receive) function. For example, Patent Document 1 discloses a module for performing communication in which two antennas acquire different channels at the same time, and the channel with higher reception sensitivity among the two received channels is used.

By utilizing such an SHDR function, the radio communication terminals can receive a standby paging channel of voice communication via the sub antenna. As a result, the radio communication terminals can monitor an incoming call via the sub antenna, while continuing data communication such as EVDO (Evolution Data Only or Evolution Data Optimized) via the main antenna.

Here, BCMCS (Broad-Cast Multi-Cast Service) is one EVDO service. The BCMCS is a service that simultaneously broadcasts particular contents to a multitude of users, and a radio communication terminal starts reception in response to the fact that notification information of broadcast beginning has been received in the communication area, or the fact that the acquisition time has come, which was set when registering an intention for acquiring contents with a content broadcast server.

At this time, in a case in which the broadcasted contents are large volumes of data, it will take so long time until completing the reception.

Patent Document 1: Japanese Unexamined Patent Application, First Publication No. 2005-184355

### DISCLOSURE OF THE INVENTION

### Problems to be Solved by the Invention

Accordingly, an objective of the present invention is to provide a communication terminal and a data reception method, with which data reception can be continued while performing intercommunication (transmission and reception) such as voice communication.

### Means for Solving the Problems

A communication terminal according to the present invention includes: a first antenna that transmits and receives a signal; a second antenna that receives a signal; and a control unit that performs communication and switches between the first antenna and the second antenna meanwhile, in which; the control unit performs standby for an incoming call with the second antenna while receiving predetermined data via the first antenna, and the control unit, in a case in which there is an incoming call while receiving the predetermined data, switches the antenna that receives the predetermined data to the second antenna, and performs response processing to the incoming call using the first antenna.

Moreover, it is preferable that the first antenna is connected to a transceiver, and the second antenna is connected to only a receiver.

In addition, it is preferable that the control unit performs two-way communication based on the incoming call via the first antenna after the response processing, and the reception of the predetermined data is continued via the second antenna concurrently while the two-way communication.

Furthermore, it is preferable that the predetermined data is broadcast data that is broadcasted from a base station to a plurality of terminals.

Moreover, it is preferable that the control unit switches the antenna that receives the predetermined data from the second antenna to the first antenna, when the two-way communication is terminated.

In addition, after the switching the antenna that receives the predetermined data from the second antenna to the first antenna, it is preferable that the control unit makes the second antenna to perform standby for an incoming call again.

Furthermore, it is preferable that the control unit monitors a paging channel via either of the first antenna and the second antenna for monitoring an incoming call, and receives the broadcast data via the first antenna from a broadcast channel that is different from the paging channel.

Moreover, it is preferable that the control unit monitors an incoming call with a CDMA2000_{—}1x method using the first antenna and the second antenna, and receives the predetermined data with an EVDO method in the broadcast channel.

In addition, it is preferable that the communication terminal according to the present invention further includes a memory unit that stores the predetermined data received via the first antenna or the second antenna, in which, after the two-way communication is terminated, the control unit decodes the predetermined data stored in the memory unit.

Furthermore, it is preferable that the first antenna and the second antenna are antennas used for diversity reception by the control unit.

Moreover, it is preferable that the control unit performs a call-notification in a case in which there is an incoming call while receiving the predetermined data via the first antenna, performs processing to switch the antenna that receives the predetermined data to the second antenna and response processing for the incoming call using the first antenna in a case in which there is a response operation for the call-notification, and continues the reception of the predetermined data via the first antenna in a case in which there is no response operation for the call-notification.

In addition, it is preferable that the control unit performs an SHDR function, and while communicating via one of the first antenna and the second antenna, the control unit receives a channel that is different from a channel in the communication via the other antenna by the SHDR function.

A data reception method according to the present invention is a data reception method in a communication terminal including a first antenna that transmits and receives a signal, and a second antenna that receives a signal, and the method includes the steps of: performing communication and switching between the first antenna and the second antenna meanwhile; performing standby for an incoming call via the second antenna while receiving predetermined data via the first antenna; switching the reception of the predetermined data to the second antenna in a case in which there is an incoming call during the reception of the predetermined data; and performing response processing to the incoming call via using the first antenna after switching the reception of the predetermined data to the second antenna.

### EFFECTS OF THE INVENTION

According to the present invention, it is possible to provide a communication terminal and a data reception method, with which data reception is continued while performing intercommunication.

### BRIEF DESCRIPTION OF THE DRAWINGS

FIG. 1 is a perspective view showing an overview of a cellular telephone device according to an example of a preferred embodiment of the present invention;

FIG. 2 is a block diagram showing each function of the cellular telephone device according to an example of the preferred embodiment of the present invention;

FIG. 3 is a diagram showing a first processing flow in a case of performing incoming call processing while receiving BCMCS;

FIG. 4 is a diagram showing, in chronological order, switching of processing between a main communication unit and a sub communication unit in response to an incoming voice call, in the first processing flow;

FIG. 5 is a diagram showing a flow of incoming call processing (second processing) while receiving BCMCS according to an example of the preferred embodiment of the present invention;

FIG. 6 is a diagram showing, in chronological order, switching of processing between the main communication unit and the sub communication unit in response to an incoming voice call, in a processing flow according to an example of the preferred embodiment of the present invention; and

FIG. 7 is a diagram showing a processing flow in a case in which BCMCS program reception is continued after terminating voice call processing in an example of the preferred embodiment of the present invention.

### EXPLANATION OF REFERENCE NUMERALS

40 main communication unit
50 sub communication unit
60 CPU
410 main antenna
420 branching filter
430 power amplifier
440 transmitting circuit unit
450 receiving circuit unit
510 sub antenna
550 receiving circuit unit
610 antenna control unit
620 communication channel processing unit
630 BCMCS channel processing unit
640 application processing unit

### PREFERRED MODE FOR CARRYING OUT THE INVENTION

A description is provided hereinafter regarding an example of a preferred embodiment according to the present invention, based on the drawings. It should be noted that, although a cellular telephone device is hereinafter described as a radio communication terminal, the present invention is not limited thereto, and it may be a PDA (Personal Digital Assistant), a portable navigation device, a notebook PC or the like.

### Structure of Cellular Telephone Device 1

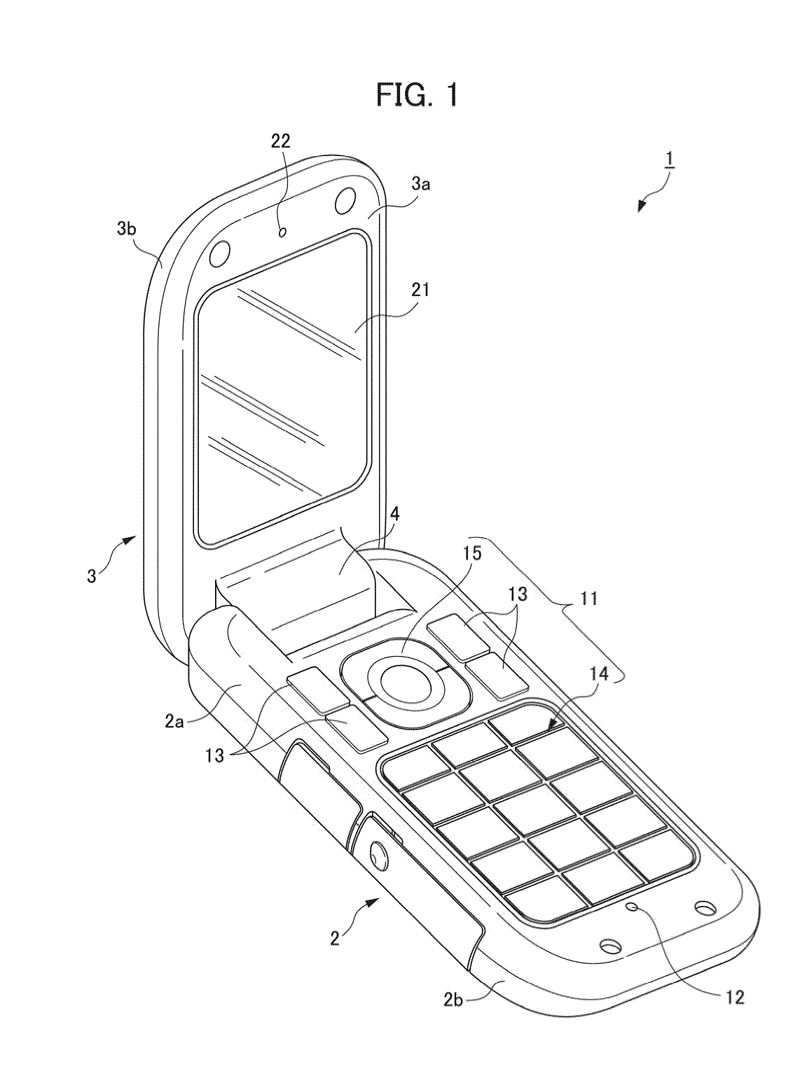

FIG. 1 is a perspective view showing an overview of a cellular telephone device 1 according to an example of a preferred embodiment of the present invention.

The cellular telephone device 1 is configured to include: an operation unit side body 2, a surface of which is configured with a front case 2a and a rear case 2b; and a display unit side body 3, a surface of which is configured with a front case 3a and a rear case 3b. The operation unit side body 2 is configured to expose, on a surface of the front case 2a, an operation key set 11 and a sound input unit 12 where the sound of the user of the cellular telephone device 1 is input when conversing. Moreover, the operation key set 11 is configured with: function setting operation keys 13 for operating various functions such as for various settings, a telephone number directory function and a mail function; input operation keys 14 for inputting digits of a telephone number and characters for mail, etc.; and selection operation keys 15 for performing selection of the various operations and scrolling, etc.

In addition, the display unit side body 3 is configured with a display 21 for displaying a variety of information and a sound output unit 22 for outputting sound of the other party of a conversation so as to be exposed on the front case 3a.

Furthermore, an upper end portion of the operation unit side body 2 and a lower end portion of the display unit side body 3 are connected via a hinge mechanism 4. Moreover, the cellular telephone device 1 can be made into a state in which the operation unit side body 2 and the display unit side body 3 are apart from each other (opened state), and into a state in which the operation unit side body 2 and the display unit side body 3 are contacting each other (folded state), by moving the operation unit side body 2 and the display unit side body 3, connected via the hinge mechanism 4, with respect to each other. It should be noted that, although the cellular telephone device 1 is described as a flip type, which is foldable by the hinge mechanism 4 in the present embodiment, it is not limited thereto. For example, instead of the flip type, the cellular telephone device 1 may be of: a slider type in which one body slides to one direction from a state in which both of the bodies 2 and 3 are mutually superimposed; a rotating type (turning type) in which one body is rotated around an axis line along the direction of the superimposion; a type in which both of the bodies 2 and 3 are connected via a 2-axis hinge; or a so-called straight type in which the operation unit side body 2 and the display unit side body 3 are disposed in a single body.

### Functional Block Diagram of Cellular Telephone Device 1

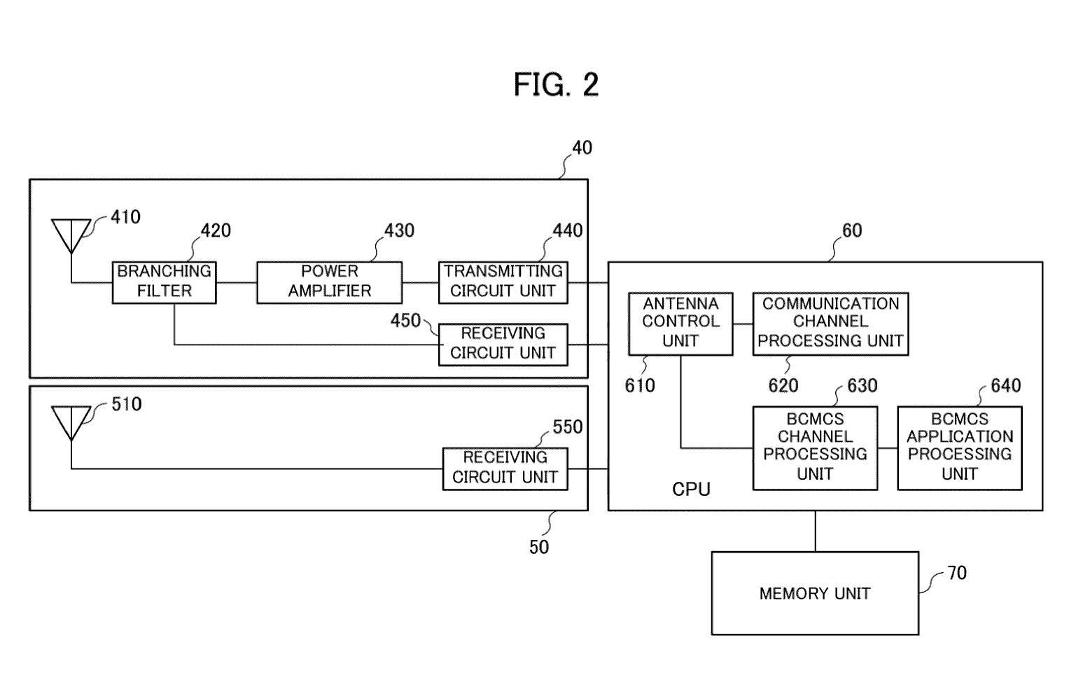

FIG. 2 is a block diagram showing each function of the cellular telephone device 1 according to an example of a preferred embodiment of the present invention.

The cellular telephone device 1 includes: a main communication unit (first communication unit) 40 that is capable of transmitting and receiving signals; a sub communication unit (second communication unit) 50 that is capable of receiving signals; a CPU (control unit) 60; and a memory unit 70. With the above units collaborating with each other, the cellular telephone device 1 selects one of a plurality of communication systems, and communicates sound and data.

Here, the communication system refers to, for example, an adapted frequency and protocol in a communication method that can be used by the cellular telephone device 1. The cellular telephone device 1 is capable of transmitting and receiving radio signals in a plurality of frequency bands, and more specifically is capable of performing communication by using an old 800 MHz band, a new 800 MHz band and a 2 GHz band. Furthermore, the cellular telephone device 1 is capable of using a plurality of methods such as CDMA2000_{—}1x or EVDO, etc. as a communication method thereof. In this way, since the protocols of CDMA2000_{—}1x and EVDO are partly shared with each other, a transmission and reception system of EVDO is necessarily compatible with CDMA2000_{—}1x as well.

The main communication unit 40 includes a main antenna 410, a branching filter 420, a power amplifier 430, a transmitting circuit unit 440 and a receiving circuit unit 450 (transceiver), and is responsible for transmitting and receiving signals to and from the aforementioned communication systems.

A transmission signal being output by the transmitting circuit unit 440 is amplified by the power amplifier 430, is passed through the branching filter 420, and is transmitted by radio to a communication system via the main antenna 410. Moreover, a received signal that has been received via the main antenna 410 is input to the receiving circuit unit 450, and the CPU 60 performs processing in accordance with the received signal.

The sub communication unit 50 includes a sub antenna 510 and a receiving circuit unit 550, and is responsible for receiving signals from the aforementioned communication systems. The received signal that has been input to the receiving circuit unit 550 via the sub antenna 510 is processed by the CPU 60. The sub communication unit 50 basically has a configuration that is similar to that of the reception side in the main communication unit 40.

The CPU 60 includes an antenna control unit 610, a communication channel processing unit 620, a BCMCS channel processing unit 630, and a BCMCS application processing unit 640.

The antenna control unit 610 performs frequency allocation processing in the main communication unit 40 and the sub communication unit 50 in accordance with a command signal from the communication channel processing unit 620 or the BCMCS channel processing unit 630. Here, since the receiving circuit units 450 and 550 each have a local oscillator, the CPU 60 can select different frequencies at the same time.

In other words, more specifically, the cellular telephone device 1 monitors a timer (not illustrated) at any time, and activates the BCMCS application processing unit 640 in a case in which the acquisition time has come, which was set in advance as the time for acquiring contents. First, the BCMCS application processing unit 640 performs a content (BCMCS program data) reception request to the BCMCS channel processing unit 630. The BCMCS channel processing unit 630 then requests the antenna control unit 610 to set an antenna periphery block for the program reception.

Incidentally, in the BCMCS, coded content data is being broadcast in one channel from the base station. Moreover, an authentication ID for acquiring broadcast data has been issued to the cellular telephone device 1, which is contracted for content acquisition. After setting the receiving circuit to a channel to be broadcast, the cellular telephone device 1 performs authentication by using this authentication ID, receives the coded content data, decodes the received content data, and stores the data in the memory unit 70. The BCMCS application processing unit 640 performs management of the authentication ID, decoding of the received content data and storing the data in the memory unit 70, as well as processing for content playback when execution of the content data is subsequently requested by the user. Moreover, the BCMCS channel processing unit 630 controls reception frequency setting for content data, synchronization setting for reception, protocol setting or the like via the antenna control unit 610, and causes the main communication unit 40 or the sub communication unit 50 to receive the BCMCS channel.

Here, in a case in which the cellular telephone device 1 performs, for example, BCMCS program reception by the main communication unit 40, the BCMCS channel processing unit 630 commands the antenna control unit 610 to allocate a BCMCS channel of EVDO to the main communication unit 40. At this time, in order to perform standby for an incoming communication request such as a voice call or an E-mail message, the communication channel processing unit 620 commands the antenna control unit 610 to allocate a standby paging channel to the sub communication unit 50.

The BCMCS application processing unit 640 requests program reception to the BCMCS channel processing unit 630, receives program data received by the main communication unit 40, and performs processing in accordance with the received program data. For example, the BCMCS application processing unit 640 performs decoding processing of compressed or coded program data to generate data for screen display.

It should be noted that, although targets for communication on standby for an incoming call include a voice call and an E-mail message, a case of an incoming voice call is described hereinafter.

### First Processing

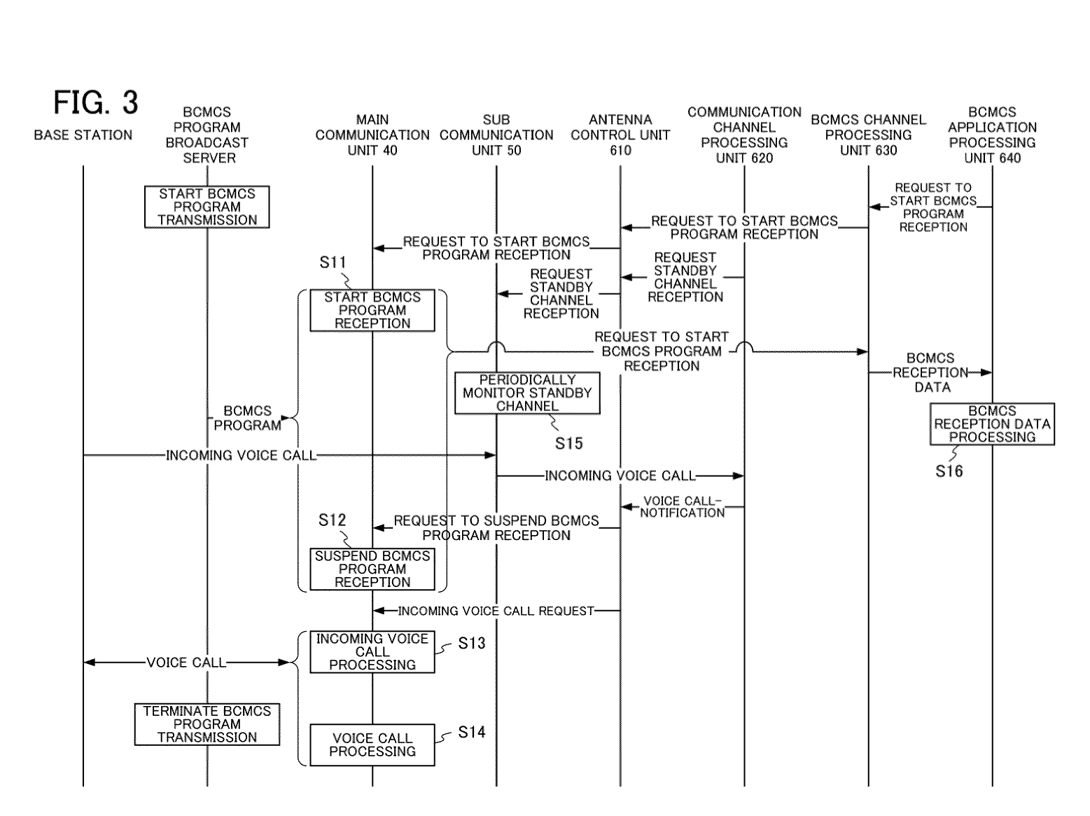

FIG. 3 is a diagram showing a first processing flow in a case of performing incoming call processing while receiving BCMCS in the cellular telephone device 1 according to an example of a preferred embodiment of the present invention. This example is described as a comparison with processing to be described later in the present embodiment.

When the content acquisition time has come, and when the main communication unit 40 has accepted a BCMCS program reception start request from the BCMCS application processing unit 640 via the BCMCS channel processing unit 630 and the antenna control unit 610, the main communication unit 40 acquires notification information from a BCMCS program broadcast server, and starts BCMCS program reception (Step S11).

The BCMCS reception data is received by the BCMCS application processing unit 640 via the BCMCS channel processing unit 630, and data processing is performed on the data (processing to store data in the memory unit 70 after performing processing to decode coded data and error correction processing) (Step S16). More specifically, the BCMCS application processing unit 640 causes, for example, the compressed or coded received data to be decoded and stored. Furthermore, the BCMCS application processing unit 640 performs predetermined processing on the stored data, and generates data for screen display to be presented to the user.

Here, while the main communication unit 40 is performing BCMCS program reception, the sub communication unit 50 accepts a standby channel reception request from the communication channel processing unit 620 via the antenna control unit 610. In this way, the sub communication unit 50 periodically monitors a standby channel (Step S15).

In a case in which the sub communication unit 50 detects the occurrence of an incoming voice call from the base station while the main communication unit 40 is performing BCMCS program reception from the BCMCS program broadcast server, the communication channel processing unit 620 notifies the antenna control unit 610 of the incoming voice call in response to the incoming voice call and additionally in response to detecting a response operation from the user.

In response to receiving the voice call-notification, the antenna control unit 610 requests the main communication unit 40 to suspend the BCMCS program reception. In this way, the main communication unit 40 suspends the BCMCS program reception (Step S12). It should be noted that the reception operation of the main communication unit 40 will be continued in the present state in a case in which there is no response operation from the user.

After suspending the BCMCS program reception, the main communication unit 40 outputs a response signal for the incoming call in response to the incoming voice call request from the antenna control unit 610, and performs incoming voice call processing (Step S13). In this way, a response to the incoming call is started, and voice call processing (two-way communication) is performed via the main communication unit 40 (Step S14).

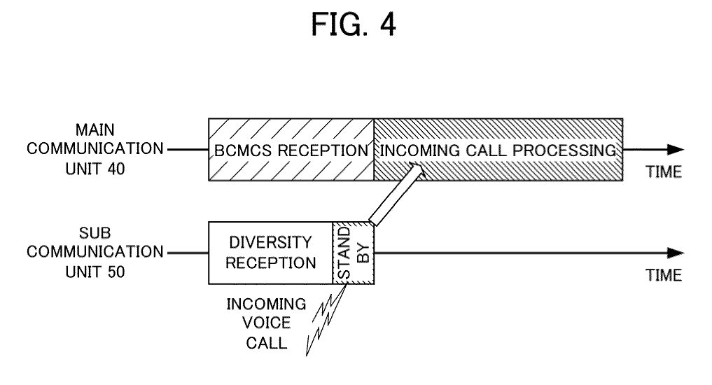

In the aforementioned processing flow, the switching of the processing between the main communication unit 40 and the sub communication unit 50 in response to an incoming voice call is shown in FIG. 4 in chronological order.

First, while the main communication unit 40 is performing BCMCS reception, the sub communication unit 50 is performing diversity reception as an aid to the main communication unit 40. The diversity reception refers to reception in which two antennas, i.e. the main antenna 410 and the sub antenna 510, are used, thereby efficiently performing reception by using one antenna with higher sensitivity.

The sub communication unit 50 periodically suspends the diversity reception, and performs standby paging channel reception. In a case in which an incoming voice call is received during this standby, the CPU 60 stops the BCMCS reception in order to perform incoming call processing by the main communication unit 40. This action is taken since the sub communication unit 50 is not capable of performing two-way communication. More specifically, the sub communication unit 50 does not include a transmitting circuit unit, and thus is not capable of controlling for transmitting a response to an incoming call to the base station.

In the aforementioned processing, once the reception of the BCMCS program is suspended in response to the incoming voice call, the reception of the BCMCS program is not resumed even in a case in which the voice call that caused the suspension is terminated. As described above, in the BCMCS, the same data is broadcasted from the base station to an unspecified number of cellular telephone devices via a particular broadcast channel or the like. Accordingly, even in a case in which one cellular telephone device 1 suspends reception in order to perform a voice call, it is not allowed to stop the data broadcast to all of the cellular telephone devices until this voice call is terminated. Therefore, the data broadcast continues even during the voice call. Accordingly, the BCMCS application processing unit 640 or the BCMCS channel processing unit 630 does not resume the reception of the BCMCS that is suspended by the voice call. Moreover, even if the cellular telephone device 1 resumes the suspended BCMCS program reception after terminating the voice call, the program data for the suspended period is missing, resulting in termination of the BCMCS program reception due to an error, thereby leading to unwanted electric power consumption. This can be prevented in second processing as described next.

### Incoming Call Processing During BCMCS Reception (Second Processing)

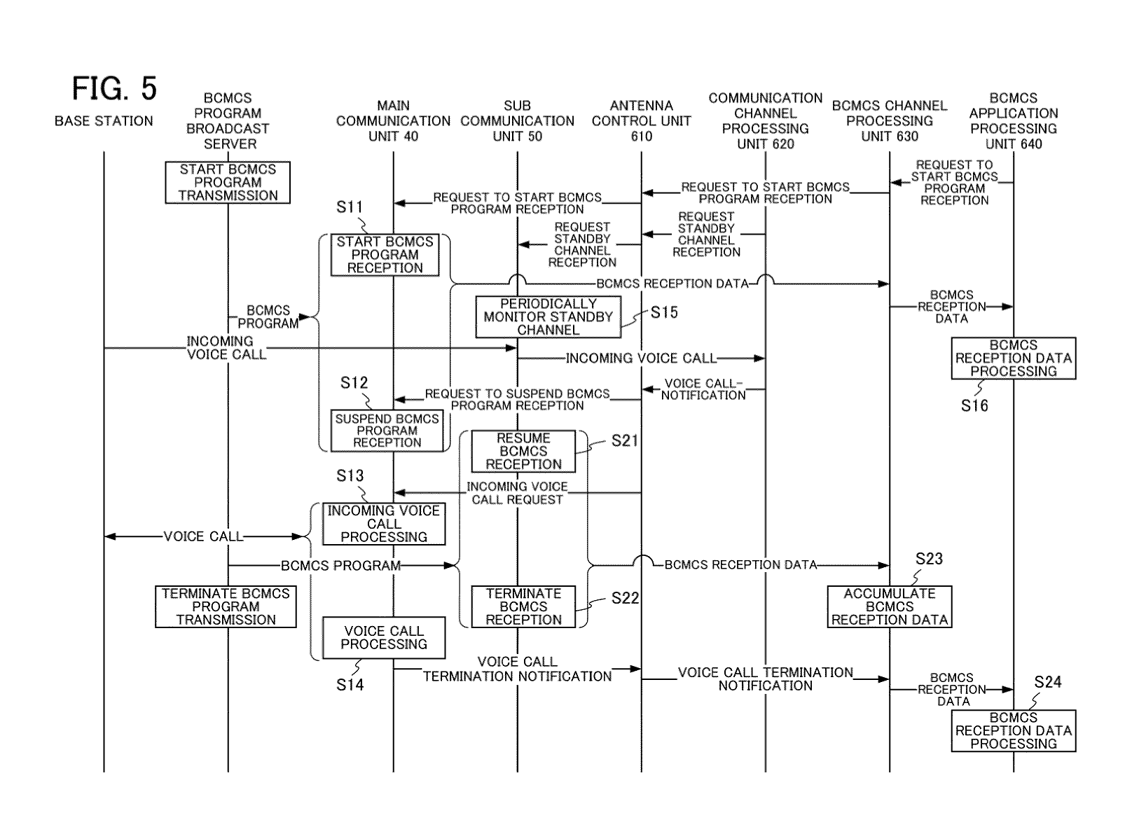

FIG. 5 is a diagram showing a flow of incoming call processing (second processing) while receiving BCMCS according to an example of a preferred embodiment of the present invention. Here, a description is omitted for the processing contents that are the same as those of the first processing.

Similarly to the first processing (FIG. 3), when the sub communication unit 50 accepts an incoming voice call by monitoring the standby channel (Step S15), the BCMCS program reception that was started by the main communication unit 40 (Step S11) is suspended in response to the CPU 60 further detecting a response operation from the user (Step S12). Again, in a case in which a response operation is not performed by the user, the reception is continued by the main communication unit 40.

Here, the CPU 60 controls such that the suspended BCMCS program reception is resumed by the sub communication unit 50 (Step S21) (the processing thereof is described later). As a result, since the reception of the program data is continued, it is not terminated due to an error. It should be noted that the switching from the main communication unit 40 to the sub communication unit 50 is merely signal processing, and the temporary suspension of reception due to the switching takes a considerably shorter period of time as compared to that for performing a voice call; therefore, an amount of received data to be missed is minimum. Therefore, the missing data can be supplemented by performing error correction with redundant data and the like that is a characteristic of BCMCS program data.

When the sub communication unit 50 resumes the BCMCS program reception, the antenna control unit 610 requests the main communication unit 40 to transmit a response to the incoming voice call. The main communication unit 40 starts incoming voice call processing in response to the request, and establishes communication with the base station (Step S13). Subsequently, the main communication unit 40 performs voice call processing with the base station with which communication has been established (Step S14).

Thereafter, when the program broadcasting by the BCMCS program broadcast server is terminated, the sub communication unit 50 terminates the BCMCS program reception (Step S22). The BCMCS reception data received up to now is stored and accumulated in the memory unit 70 by the BCMCS channel processing unit 630 (Step S23).

Here, in a case in which the CPU 60 does not perform accumulation of the received data as in Step S23, but performs decoding of the received data and the like similarly to Step S16, a great processing load is placed on the CPU 60. In other words, in addition to processing such as decoding of the received data of the BCMCS program, the incoming voice call processing that was started in Step S13 is performed; therefore, the cellular telephone device 1 needs to be equipped with a CPU having high performance relative to the first processing.

However, in the present embodiment, the CPU 60 temporarily stores and accumulates as is the received data as received data before the processing such as decoding or error correction, and thus the processing such as the decoding of the received data can be performed (Step S24) after terminating the incoming voice call processing (Step S13) and the voice call processing (Step S14). As a result, the incoming voice call/voice call processing and received data processing, of which the load is great, are not performed at the same time, and thus it is not necessary to enhance the performance of the CPU 60. Therefore, it is possible to reduce the cost of the cellular telephone device 1.

When the voice call processing (Step S14) is terminated, the main communication unit 40 notifies the BCMCS channel processing unit 630 of the termination of the voice call via the antenna control unit 610. The BCMCS application processing unit 640 receives the received and stored data from the BCMCS channel processing unit 630, and performs data processing such as decoding and screen display (Step S24).

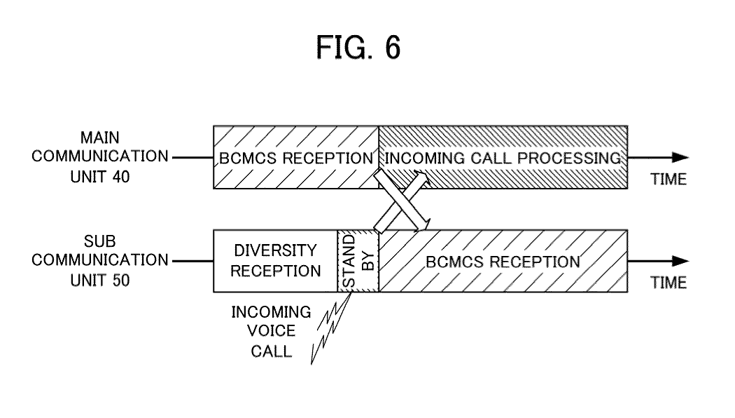

In the aforementioned processing flow, the switching of the processing between the main communication unit 40 and the sub communication unit 50 in response to an incoming voice call is shown in FIG. 6 in chronological order.

First, similarly to the first processing (FIG. 4), while the main communication unit 40 is performing BCMCS reception, the sub communication unit 50 is performing diversity reception as an aid to the main communication unit 40.

Here, the sub communication unit 50 periodically suspends the diversity reception, and performs standby paging channel reception. In a case in which an incoming voice call is received during the standby, the CPU 60 continues the BCMCS reception by switching to the sub communication unit 50. In this way, the BCMCS reception that does not require data transmission is performed by the sub communication unit 50, thereby enabling the main communication unit 40 to start incoming call processing.

As a result, the cellular telephone device 1 can perform processing in accordance with an incoming voice call while continuing the BCMCS reception, without terminating the BCMCS reception as in the case of the first processing.

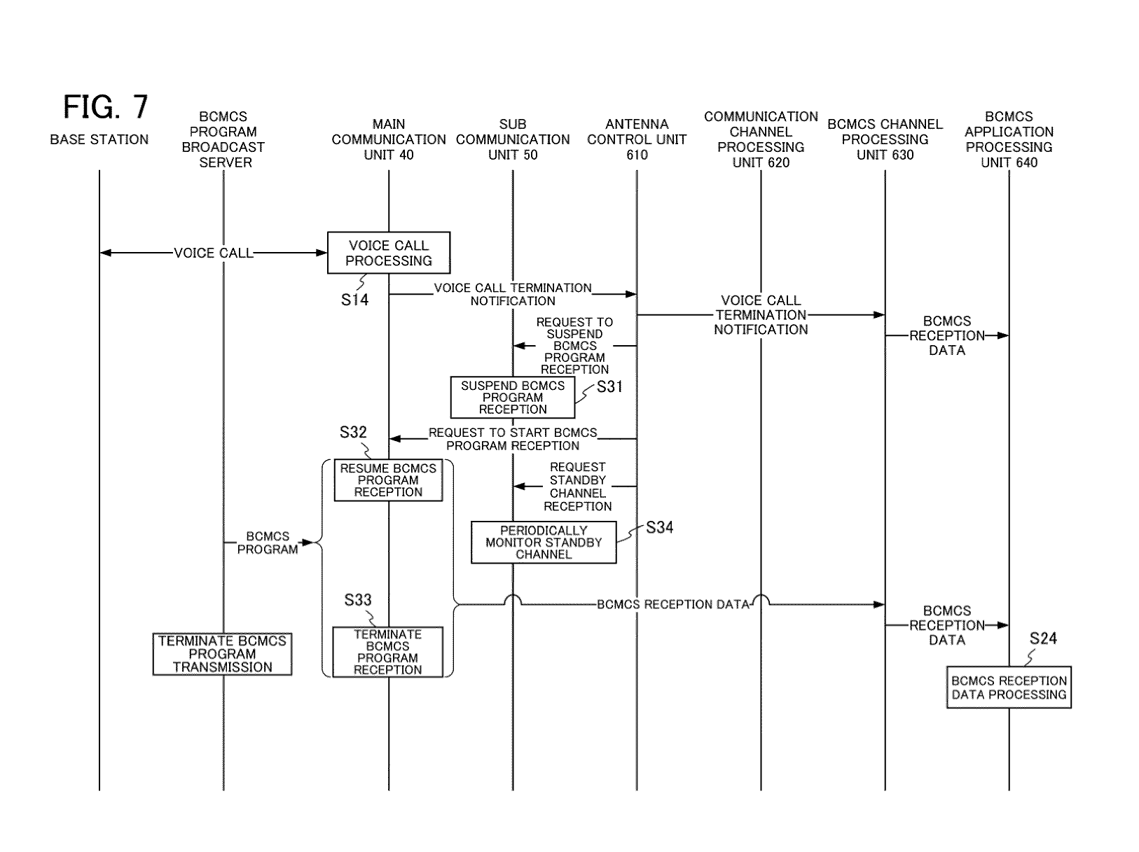

It should be noted that, although a case is illustrated in FIG. 5 in which the BCMCS program reception is terminated (Step S22) before the voice call processing (Step S14), the BCMCS program transmission may be continued after terminating a voice call in some cases. In that case, the CPU 60 may switch the BCMCS program reception to the main communication unit 40 again. FIG. 7 shows a processing flow in a case in which the BCMCS program reception is continued after terminating the voice call processing.

When the voice call processing (Step S14) is terminated, in response to voice call termination notification, the antenna control unit 610 requests the sub communication unit 50 to suspend the BCMCS program reception, and requests the main communication unit 40 to start BCMCS program reception. In this way, the sub communication unit 50 suspends the BCMCS program reception (Step S31), and the main communication unit 40 resumes the BCMCS program reception (Step S32).

Furthermore, in response to a request from the antenna control unit 610, the sub communication unit 50 resumes the periodical monitoring of a standby channel (Step S34).

Thereafter, when the transmission of the BCMCS program is terminated, the main communication unit 40 terminates the BCMCS program reception (Step S33). The BCMCS reception data up to this point is transmitted to the BCMCS application processing unit 640 via the BCMCS channel processing unit 630, and the BCMCS application processing unit 640 performs data processing such as decoding (Step S24).

It should be noted that the BCMCS reception data may be stored in the memory unit 70 by the BCMCS channel processing unit 630 similarly to Step S23 (FIG. 5). In that case, in response to termination of the BCMCS program reception (Step S33), the BCMCS channel processing unit 630 receives program reception termination notification, and transmits the stored BCMCS reception data to the BCMCS application processing unit 640.

In this way, by resuming the BCMCS program reception by the main communication unit 40 after terminating the voice call, the cellular telephone device 1 can perform data reception by using an antenna with high sensitivity. As a result, a possibility of failing in the middle of BCMCS program reception can be reduced.

It should be noted that, in the CDMA2000_{—}1x_EVDO method, the EVDO is dedicated for data communication, and the communication rate thereof is correspondingly higher than that of the 1x method. Moreover, the 1x method can be used for both voice communication and data communication. Accordingly, standby (a state of waiting for an incoming call or the like while communication is not being performed) is basically performed by the 1x method. On the other hand, the cellular telephone device 1 determines beforehand whether the base station in the communication-enabled area supports the EVDO method, and when starting data communication, a communication system of the EVDO method is selected in a case in which the EVDO method is available, and a communication system of the 1x method is selected in a case in which the EVDO method is not available, thereby starting communication with the base station.

Accordingly, at first, in a standby state in which none of BCMCS reception, voice reception or data reception is performed, the main communication unit 40 is performing standby by using a communication system of the 1x method. Thereafter, when BCMCS reception is performed by the main communication unit 40, the main communication unit 40 is switched to a communication system of the EVDO method. BCMCS channels are supported only by the EVDO method due to its characteristic of broadcasting mass data. At this time, the sub communication unit 50 configures a diversity receiving unit in the EVDO communication. In other words, the sub communication unit 50 also monitors the signal status of the communication system of the EVDO method, and in a case in which the reception environment is better than the reception status in the main communication unit 40, BCMCS data is received by the sub communication unit 50. At this time, as described above, the occurrence of an incoming voice call is periodically monitored. In other words, a standby channel will be selected, for which notification is periodically made by a communication system of the 1x method.

Moreover, when notification of an incoming voice call is received by the 1x method while BCMCS reception is being performed by the main communication unit 40, the CPU 60 switches the BCMCS reception to the sub communication unit 50 as described above, and starts processing of the incoming voice call by the main communication unit 40. In other words, the antenna control unit 610 is performing processing such that BCMCS reception by the main communication unit 40 is suspended, the communication system used by the main communication unit 40 is switched to the 1x method, thereafter incoming call response processing is performed, the communication system used by the sub communication unit 50 is switched to the EVDO method, and the suspended BCMCS reception is resumed. In this way, by causing the antenna control unit 610 to control so as to adequately change a communication system used by each communication unit, communication can be performed over a plurality of communication systems without fatally stopping communication among each other.

By using the aforementioned SHDR technique, a radio communication terminal can monitor an incoming call such as voice communication even while receiving BCMCS data; however, a sub antenna is generally limited in functions as compared to a main antenna, and is not provided with a transmitting function in many cases. Therefore, in order to respond to such an incoming call, it is necessary to use a main antenna that is capable of transmitting and receiving data.

However, since the main antenna is receiving BCMCS data, this data reception will be terminated in order to respond to the incoming call. In the case of BCMCS, since reception cannot be resumed after responding to an incoming call, communication with a server is established again to receive data, in order for a radio communication terminal to acquire data. In that case, the user may suffer from an inconvenience such as an additional operation or charging for a data request. According to the aforementioned embodiment, such an inconvenience can be avoided.

Although an embodiment of the present invention has been described above, the present invention is not limited to the aforementioned embodiment. Moreover, the effects described in the embodiment of the present invention merely exemplify the most preferable effects arising from the present invention, and the effects according to the present invention are not limited to those described in the embodiment of the present invention.

For example, several examples may occur as a trigger for starting data reception. Although the starting of BCMCS data reception when the set time has come has been described above, it is not limited thereto.

For example, in a standby state of communication, a paging channel is monitored via the main antenna 410. Moreover, monitoring is performed of whether notification has been made for information notifying broadcast occurrence of broadcast information in the paging channel, and when the CPU 60 detects broadcast occurrence, the start of data reception by the main communication unit 40 may be triggered. In this case, when broadcast information is confirmed in the paging channel, the main communication unit 40 transitions to a designated data reception channel to receive data, and the sub communication unit 50 monitors a paging channel again. Subsequent processing is similar to that in the aforementioned example.

Moreover, although the CDMA2000_{—}1x method has been mainly described in the aforementioned example, it is not limited thereto, and obviously may be W-CDMA (Wide Band CDMA), for example.

It should be noted that standby for an incoming call is performed by monitoring a paging channel with CDMA2000_{—}1x. In addition, in a case in which a request for starting data communication is made by the user, it is determined whether a nearby base station is enabled for EVDO communication, and when it is enabled for EVDO communication, data communication by EVDO is performed. However, in a case in which the area is a non-EVDO-communication-compliant area, such as a case in which there are no nearby base stations compliant with EVDO, even data communication is performed with CDMA2000_{—}1x. Furthermore, a voice call is also performed with CDMA2000_{—}1x.

1. A communication terminal, comprising:
a first antenna that transmits and receives a signal;
a second antenna that receives a signal; and
a control unit that performs communication and switches between the first antenna and the second antenna meanwhile,
wherein;
the control unit performs standby for an incoming call with the second antenna while receiving predetermined data via the first antenna, and
the control unit, in a case in which there is an incoming call while receiving the predetermined data, switches the antenna that receives the predetermined data to the second antenna, and performs response processing to the incoming call using the first antenna.

2. The communication terminal according to claim 1,
wherein the first antenna is connected to a transceiver, and
the second antenna is connected to only a receiver.

3. The communication terminal according to claim 2,
wherein, the control unit performs two-way communication based on the incoming call via the first antenna after the response processing, and the reception of the predetermined data is continued via the second antenna concurrently while the two-way communication.

4. The communication terminal according to claim 3,
wherein the predetermined data is broadcast data that is broadcasted from a base station to a plurality of terminals.

5. The communication terminal according to claim 3,
wherein the control unit switches the antenna that receives the predetermined data from the second antenna to the first antenna, when the two-way communication is terminated.

6. The communication terminal according to claim 5,
wherein, after the switching the antenna that receives the predetermined data from the second antenna to the first antenna, the control unit makes the second antenna to perform standby for an incoming call again.

7. The communication terminal according to claim 4,
wherein the control unit monitors a paging channel via either of the first antenna and the second antenna for monitoring an incoming call, and receives the broadcast data via the first antenna from a broadcast channel that is different from the paging channel.

8. The communication terminal according to claim 7,
wherein the control unit monitors an incoming call with a CDMA2000_{—}1x method using the first antenna and the second antenna, and receives the predetermined data with an EVDO method in the broadcast channel.

9. The communication terminal according to claim 3,
further comprising a memory unit that stores the predetermined data received via the first antenna or the second antenna,
wherein, after the two-way communication is terminated, the control unit decodes the predetermined data stored in the memory unit.

10. The communication terminal according to claim 1,
wherein the first antenna and the second antenna are antennas used for diversity reception by the control unit.

11. The communication terminal according to claim 1,
wherein;
the control unit
performs a call-notification in a case in which there is an incoming call while receiving the predetermined data via the first antenna, and
performs processing to switch the antenna that receives the predetermined data to the second antenna and response processing for the incoming call using the first antenna in a case in which there is a response operation for the call-notification, and
continues the reception of the predetermined data via the first antenna in a case in which there is no response operation for the call-notification.

12. The communication terminal according to claim 8,
wherein the control unit performs an SHDR (Simultaneous Hybrid Dual Receive) function, and
while communicating via one of the first antenna and the second antenna, the control unit receives a channel that is different from a channel in the communication via the other antenna by the SHDR function.

13. A data reception method in a communication terminal including a first antenna that transmits and receives a signal, and a second antenna that receives a signal, the method comprising the steps of:
performing communication and switching between the first antenna and the second antenna meanwhile;
performing standby for an incoming call via the second antenna while receiving predetermined data via the first antenna;
switching the reception of the predetermined data to the second antenna in a case in which there is an incoming call during the reception of the predetermined data; and
performing response processing to the incoming call via the first antenna after switching the reception of the predetermined data to the second antenna.
